(19) United States
(12) Patent Application Publication
(10) Pub. No.: US 2013/0156143 A1
(43) Pub. Date: Jun. 20, 2013

(54) EMERGENCY CORE COOLING SYSTEM (ECCS) FOR NUCLEAR REACTOR EMPLOYING CLOSED HEAT TRANSFER PATHWAYS

(71) Applicant: Billy E. Bingham, Lynchburg, VA (US)

(72) Inventor: Billy E. Bingham, Lynchburg, VA (US)

(21) Appl. No.: 13/325,603

(22) Filed: Dec. 14, 2011

(51) Int. Cl. G21C 9/00; F28D 15/04

(52) U.S. Cl. 376/298; 165/104.26

(57) ABSTRACT

A containment structure contains an interior volume, and a nuclear reactor is disposed in the interior volume. An ultimate heat sink pool is disposed outside of the containment structure. A condenser includes a plurality of closed-path heat pipes or closed-path thermosiphons having first ends and opposite second ends. The closed-path heat pipes or closed-path thermosiphons are embedded in the containment structure with the first ends protruding into the interior volume and the second ends protruding outside of the containment structure.

### BACKGROUND

The following relates to the nuclear reactor arts, nuclear power generation arts, nuclear safety arts, and related arts.

Nuclear reactor safety centers upon maintaining the radioactive core in an immersed condition with adequate heat removal. During normal operation, the reactor core is disposed in a sealed reactor pressure vessel that is filled (or mostly filled) with primary coolant (e.g., light water, in the case of a light water reactor). Heat removal is provided by circulation of the primary coolant through a “heat sink”. In the case of a nuclear power plant, the “heat sink” usually takes the form of a steam generator or turbine. In a conventional boiling water reactor (BWR) the primary coolant is converted to steam inside the pressure vessel and piped out to directly drive a turbine where the act of performing useful work on the turbine cools the steam. In a conventional pressurized water reactor (PWR) primary coolant in a subcooled liquid phase is piped into an external steam generator where heat is transferred to a secondary coolant that in turn drives the turbine. In an integral PWR design an “integral” steam generator is located inside the pressure vessel. In this variant design secondary coolant feedwater is piped into the steam generator and secondary coolant steam is piped out of the steam generator.

Safety systems are designed to remediate various possible events that could compromise the objective of keeping the reactor core immersed in primary coolant and adequately cooled. Two possible events that are addressed by the safety systems are: a loss of coolant accident (LOCA); and a loss of heat sinking accident. Conventionally, safety systems include: (1) a steel containment structure surrounding the pressure vessel and of sufficient structural strength to contain released primary coolant steam; (2) an ultimate heat sink (UHS) comprising a pool of water located outside of the containment; and (3) an emergency core cooling system (EGGS) comprising a combination of condensers to condense steam into water and reject the heat to the UHS. Additionally, a refueling water storage tank (RWST) located inside the containment structure to provide water during refueling operations can also serve as a source of water in emergencies. The steam recaptured by the condensers is optionally fed back into the RWST or the reactor coolant inventory and purification system (RCIPS). The UHS is designed to contain a sufficient supply of water to dissipate heat from the reactor for a designated time period (e.g. 72 hours or for two weeks in some regulatory schemes) without replenishment of the water in the UHS.

In a LOCA, a rupture in the pressure vessel or in connecting piping (e.g., pipes conducting primary coolant to/from an external turbine or steam generator) may cause the pressure vessel to depressurize and possibly leak primary coolant. Remediation of a LOCA includes (1) containing and condensing primary coolant steam in order to depressurize the system; and (2) replenishing water to the pressure vessel in order to keep the reactor core immersed. The RWST provides replenishment water, while the ECCS condensers condense the steam to control pressure within containment.

In a loss of heat sinking event the “heat sink” is lost either through loss of primary coolant flow to the turbine (in a BWR) or to the external steam generator (in a PWR), or through loss of feedwater to the steam generator (in either a PWR or an integral PWR). Response to loss of heat sinking includes venting steam from the pressure vessel to the ECCS condensers in order to remove heat and controllably depressurize the pressure vessel. Ideally this will be performed using a closed system in which steam from the pressure vessel is vented into the condensers. However, if the pressure rise due to loss of heat sinking is too rapid it may be necessary to vent into the containment structure (in effect, converting the loss of heat sinking event into a controlled LOCA).

The high pressure (i.e., steam) loop of the ECCS condensers are connected with the pressure vessel in a loss of heat sinking accident, and/or are connected inside the containment structure in a LOCA or a heat sinking accident in which the pressure vessel is vented to containment. The low pressure (i.e., coolant fluid) loop of the ECCS condensers are connected with the UHS via suitable piping, which must pass through the containment structure in order to provide fluid communication between the EGGS condensers inside containment and the UHS which is outside of containment. This piping presents a potential safety hazard since a break in the pipe may result in a primary leak from containment. In a LOCA this can result in venting of radioactive primary coolant steam into the outside atmosphere.

### BRIEF SUMMARY

In one aspect of the disclosure, a nuclear reactor includes a pressure vessel and a nuclear reactor core contained in the pressure vessel. A containment structure contains the nuclear reactor. An ultimate heat sink pool is disposed outside of the containment structure. A condenser includes a plurality of closed-path heat pipes or closed-path thermosiphons having first ends and opposite second ends. The closed path heat pipes or thermosiphons are embedded in the containment structure with the first ends contained inside the containment structure and the second ends disposed outside of the containment structure. The second ends are in thermal communication with the ultimate heat sink pool.

In another aspect of the disclosure, a condenser includes a plurality of closed path heat pipes or closed path thermosiphons having first ends and opposite second ends, and a plenum chamber containing the first ends. The plenum chamber has a fluid inlet and a fluid outlet.

In another aspect of the disclosure, a containment structure contains an interior volume, and a nuclear reactor is disposed in the interior volume. An ultimate heat sink pool is disposed outside of the containment structure. A condenser includes a plurality of closed-path heat pipes or closed-path thermosiphons having first ends and opposite second ends. The closed-path heat pipes or closed-path thermosiphons are embedded in the containment structure with the first ends protruding into the interior volume and the second ends protruding outside of the containment structure.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows a side sectional view of a nuclear reactor facility including a condenser embodiment as disclosed herein.

FIGS. 2 and 3 diagrammatically show side sectional and top views, respectively, of another condenser embodiment disclosed herein.

FIG. 4 diagrammatically shows a side sectional view of another condenser embodiment as disclosed herein.

FIG. 5 diagrammatically shows a side sectional view of a nuclear reactor facility including yet another condenser embodiment as disclosed herein.

### DETAILED DESCRIPTION OF THE PREFERRED EMBODIMENTS

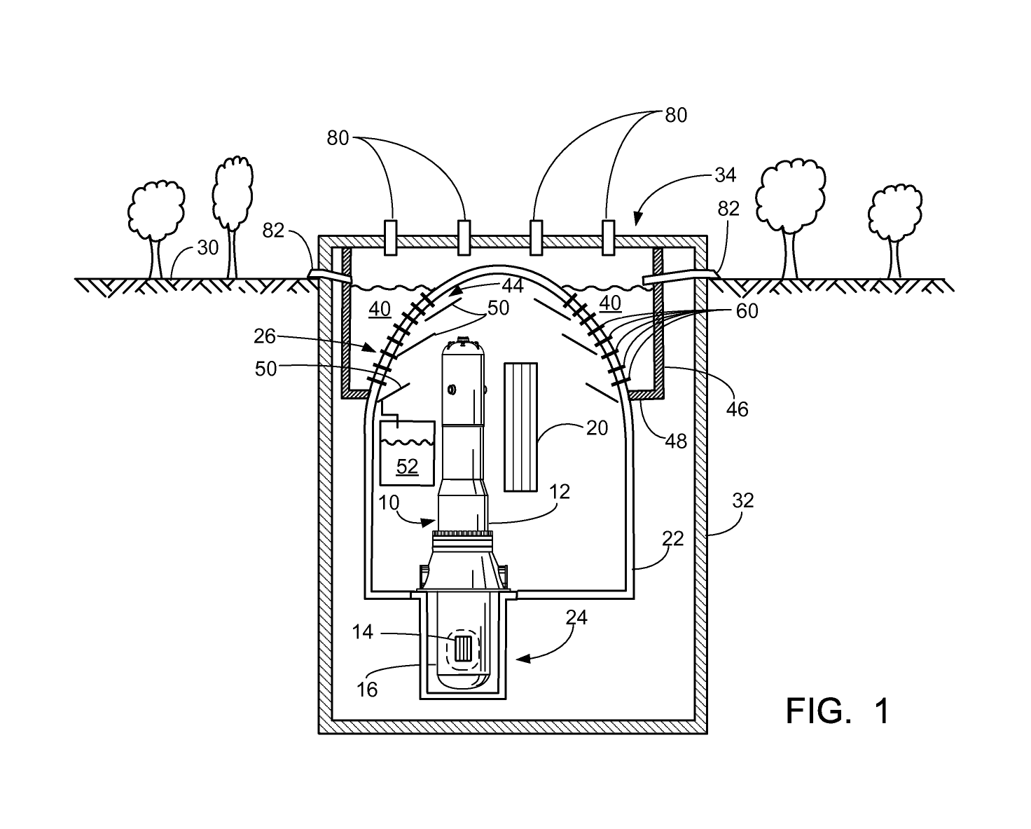

With reference to FIG. 1, an illustrative nuclear reactor of the pressurized water reactor (PWR) type 10 includes a pressure vessel 12, which in the illustrative embodiment is a cylindrical vertically mounted vessel. (Note that the term “cylindrical” as used herein does not require a mathematically precise cylinder, but rather allows for deviations such as changes in diameter along the length of the cylinder axis, inclusion of vessel penetrations or other localized features, or so forth). A nuclear reactor core 14 is disposed in a lower portion of the pressure vessel 12. (Note that in diagrammatic FIG. 1 the reactor core 14 is revealed by a cutaway 16 in the pressure vessel 12). The reactor core 14 includes a mass of fissile material, such as a material containing uranium oxide (UO₂) that is enriched in the fissile ²³⁵U isotope, in a suitable matrix material. In a typical configuration, the fissile material is arranged as “fuel rods” arranged in a core basket. The pressure vessel 12 contains primary coolant water (typically light water, that is, H₂O, although heavy water, that is, D₂O, is also contemplated) in a subcooled state.

The PWR 10 includes other components known in the art that are not shown, such as a “basket” or other structure supporting the reactor core 14 in the pressure vessel 12, neutron-absorbing control rods selectively inserted into the reactor core 14 by a control rod drive mechanism (CRDM) to control the nuclear chain reaction, a central riser that defines a primary coolant pressure boundary, primary coolant pumps, or so forth. These various components may be variously disposed inside or outside the pressure vessel. For example, the CRDM may be external, as is conventionally the case, or may be located internally inside the pressure vessel as described in Stambaugh et al., “Control Rod Drive Mechanism for Nuclear Reactor”, U.S. Pub. No. 2010/0316177 A1 published Dec. 16, 2010 which is incorporated herein by reference in its entirety; and Stambaugh et al., “Control Rod Drive Mechanism for Nuclear Reactor”, Intl Pub. WO 2010/144563 A1 published Dec. 16, 2010 which is incorporated herein by reference in its entirety. The reactor coolant pumps may be internal or external, and in some embodiments may be omitted entirely in which case heat generated by the reactor core 14 drives primary coolant flow via natural circulation.

The illustrative PWR 10 is an integral PWR design, by which it is meant that an internal steam generator is disposed in the pressure vessel 12. The installed steam generator is not shown due to the opacity of the pressure vessel 12; however, FIG. 1 diagrammatically shows a removed internal steam generator 20 that has been removed from the pressure vessel 12 for maintenance, or is located as shown prior to installation into the pressure vessel 12, or so forth. Additional conventional components are not shown, such as a crane for lifting an upper pressure vessel section in order to open the pressure vessel 12 and for moving the steam generator 20; various scaffolding, walkways or the like for movement of personnel, various auxiliary equipment and electronics, and so forth.

The PWR 10 is contained in a containment structure 22. The containment structure 22 is typically a steel structure in order to provide structural strength. The use of a steel structure also provides high thermal conductivity to facilitate removal of heat from inside the containment structure 22. Instead of steel, other materials are also contemplated for the containment structure 22. For example, portions or all of the containment structure 22 may be made of steel-reinforced concrete, a composite material such as a steel host with embedded nanoparticles to enhance thermal conductivity, or so forth.

The illustrative containment structure 22 is generally cylindrical, and further includes a lower flood well 24 and an upper dome 26. The lower flood well 24 contains the lower portion of the pressure vessel 12 including the reactor core 14. The flood well 24 enables the lower portion of the pressure vessel 12 to be flooded with water in certain emergency situations in order to assist in cooling the reactor core 14. The upper dome 26 provides enhanced structural strength and serves as a steam condensation surface in certain emergency situations. The containment structure 22 is large enough to accommodate the PWR 10 and to additionally provide space for operations such as removing the steam generator 20 during installation and/or maintenance.

The illustrative containment structure 22 is subterranean, by which it is meant that at least a portion of the containment structure 22 lies below grade, that is, at least partially below the ground level 30. A secondary containment structure 32 contains the (primary) containment structure 22. The secondary containment structure 32 is typically made of concrete, steel-reinforced concrete, or another suitably robust building material. The illustrative secondary containment structure 32 is also subterranean in order to “contain” the subterranean primary containment structure 22. An upper “roof” 34 of the secondary containment structure 32 is above-ground. In some embodiment the upper roof 34 includes vents 80 arranged to allow water evaporated or boiled off of the UHS pool 40 to escape from the secondary containment structure 32. Refilling inlets 82 may also be utilized to refill and/or maintain ultimate heat sink water level.

In the illustrative system of FIG. 1, an ultimate heat sink (UHS) pool 40 is located at-grade (that is, at ground level) and is in thermal communication with the upper dome 26 of the containment structure 22. Indeed, in the illustrative arrangement the upper dome 26 forms a wall or roof that serves as at least a portion of the “bottom” and/or “side” of the UHS pool 40. An inside surface 44 of the dome 26 serves as a condensation surface that is cooled by the UHS pool 40. The UHS pool 40 is contained by the upper dome 26 defining at least a portion of the “bottom” and/or “side” of the pool 40 along with sidewalls 46 and, in the illustrative embodiment, an additional bottom portion 48 that is welded with (or otherwise in sealed connection with) the upper dome 26. In some embodiments the additional bottom portion 48 may be omitted and the sidewalls 46 are instead welded directly with (or otherwise in direct sealed connection with) the upper dome 26.

The upper portion (i.e., roof 34) of the secondary containment structure 32 is optionally omitted. Including the roof 34 enables better control over the composition (e.g., chemistry) of the UHS pool 40, and prevents debris from falling into the UHS pool 40. In some embodiments the UHS pool is provided with a cover that is separate from the secondary containment structure. On the other hand, in some embodiments the sidewalls 46 and optional bottom portion 48 of the UHS pool may form part of the secondary containment structure. More generally, various levels and degrees of integration and/or separation between the walls and bottom of the UHS pool 40, on the one hand, and the walls and roof of the secondary containment 32 on the other hand, are contemplated. It is also contemplated to omit the secondary containment structure 32 entirely, if such an omission does not compromise safety and does not violate applicable nuclear regulatory standards.

The UHS pool 40 provides passive heat removal as follows. Primary coolant released from the pressure vessel 12 (whether in an uncontrolled LOCA or in a controlled fashion such as may be performed in a loss of heat sinking event) naturally rises and contacts the inside surface 44 of the dome 26. The UHS pool 40 in contact with the dome 26 (or, more generally, with a wall and/or roof of the containment structure 22) keeps the dome 26 at outside ambient temperature (or, more precisely, at about the temperature of the water in the UHS pool 40, which is at or close to outside ambient temperature). The primary coolant steam thus condenses onto the inside surface 44 of the dome 26 to form condensate, and its latent heat and any additional kinetic energy is transferred through the dome 26 to the UHS pool 40.

The condensate is in the form of water (or water droplets) adhering to the inside surface 44 of the dome 26. This water falls or runs downward along the surface under the influence of gravity. Advantageously, this may result in a substantial portion of the condensed water flowing into the flood well 24 to contribute to flooding the flood well 24. Alternatively, baffles 50 may be provided to guide the flow of the condensed water. In the illustrative embodiment the baffles 50 are arranged to guide the condensed water into a refueling water storage tank (RWST) 52 which is used in some emergency conditions (such as some LOCA events) to replenish water in the pressure vessel 12.

Arrangements such as that shown in FIG. 1, in which the UHS pool 40 is in contact with the containment structure 22 with sides and/or a roof of the containment structure 22 forming a portion of the bottom and/or sides of the UHS pool 40, are disclosed in further detail in “Pressurized Water Reactor With Compact Passive Safety Systems”, U.S. application Ser. No. 13/217,941 filed Aug. 25, 2011. U.S. application Ser. No. 13/217,941 filed Aug. 25, 2011 is incorporated herein by reference in its entirety.

With continuing reference to FIG. 1, a plurality of closed-path heat pipes or closed-path thermosiphons 60 are embedded in the containment structure 22, and more particularly in the roof or wall (e.g., dome 26) that forms a portion of a bottom or side of the UHS pool 40. The closed-path heat pipes or closed-path thermosiphons 60 have first ends and opposite second ends, and are embedded with their first ends contained inside the containment structure 22 and their second ends disposed outside of the containment structure 22 and immersed in the UHS pool 40.

Closed-path thermosiphons are closed tubes containing a working fluid such as liquid water. When one end of the thermosiphon is heated relative to the opposite end, this creates natural convection of the working fluid in the thermosiphon which transfers heat via convection from the hotter end to the cooler end. The convection currents within the thermosiphon are defined in part by the gravitational acceleration, and accordingly thermosiphons generally operate most efficiently when oriented vertically (as defined respective to the gravitational field) with the hotter end facing down and the cooler end facing up. In normal operation, the working fluid inside the thermosiphon is generally single-phase (e.g., liquid water). However, phase change (e.g., boiling of liquid water inside the thermosiphon) may occur when the temperature of the working fluid at the hot end of the thermosiphon exceeds its boiling point. This is sometimes referred to as the “reboiling” operational mode of the thermosiphon. In this case the higher buoyancy of the gas phase versus the liquid phase helps drive the convection that provides the heat transfer.

A heat pipe is also a closed tube containing a working fluid. However, the heat pipe does not transfer heat by convection, but rather by performing an evaporation/condensation cycle with evaporation of the working fluid occurring at the hotter end and condensation of the working fluid occurring at the opposite lower end. Mass transfer of the condensate back to the hotter end can be driven by gravity, in which case the heat pipe exhibits a high degree of orientational dependence with most efficient operation occurring in the vertical orientation with the hotter end facing down and the cooler end facing up. Optionally, a wicking structure can be disposed inside the heat pipe in order to provide mass transfer of condensate to the hotter end by capillary action. The wicking structure substantially reduces the dependency of heat transfer on heat pipe orientation, and indeed a heat pipe with a suitable wicking structure can be operated efficiently even in a horizontal position.

The term “closed-path” (i.e., “closed path heat pipes or closed-path thermosiphons”) clarifies that the heat pipe or thermosiphon operates as a closed system, with the tube being sealed and having no inlet and no outlet. In other words, the working fluid is permanently trapped inside the closed-path thermosiphon or heat pipe.

With continuing reference to FIG. 1, during a LOCA the hot primary coolant escapes as hot steam from the pressure vessel into the interior volume of the containment structure 22. This hot steam contacts the first ends of the closed-path heat pipes or closed-path thermosiphons 60 such that the first ends are the hotter ends and the second ends, which are immersed in the UHS pool 40, are the cooler ends. Accordingly, heat is transferred from the steam to the UHS pool 40, either by convection (in the case of closed path thermosiphons 60) or by an evaporation/condensation cycle (in the case of closed path heat pipes 60).

The closed-path heat pipes or closed-path thermosiphons 60 are closed heat transfer pathways 60, in contrast with conventional condenser arrangements in which water from the UHS pool is piped through the wall (or roof) of the containment structure into its interior and back out. A single break in the closed heat transfer pathways disclosed herein cannot breach containment. Rather, to breach containment a minimum of two breaks in a single thermosiphon or heat pipe 60 is needed—a break of the first end protruding into the containment structure 22, and also a break of the second end protruding out of the containment structure 22. This is a consequence of the thermosiphon or heat pipe 60 being a closed path, i.e. sealed at both ends. In contrast, a pipe conducting water to or from the UHS pool can breach containment with a single pipe break.

The approach shown in FIG. 1 enables the entire dome 26, or at least the portion of the dome 26 in contact with the UHS pool 40 in cooperation with the closed heat transfer pathways 60, to serve as a condenser. However, that condenser only operates on the interior volume of the containment structure 22 as a whole. In some applications, it may be desired to pipe steam to the condenser and condensate away from the condenser. For example, in the case of a loss of heat sinking accident that does not include a loss of coolant, it would be preferable to pipe the steam from the pressure vessel into a condenser in order to control the pressure rise, rather than letting it escape into (and contaminate) the interior volume of the containment structure 22.

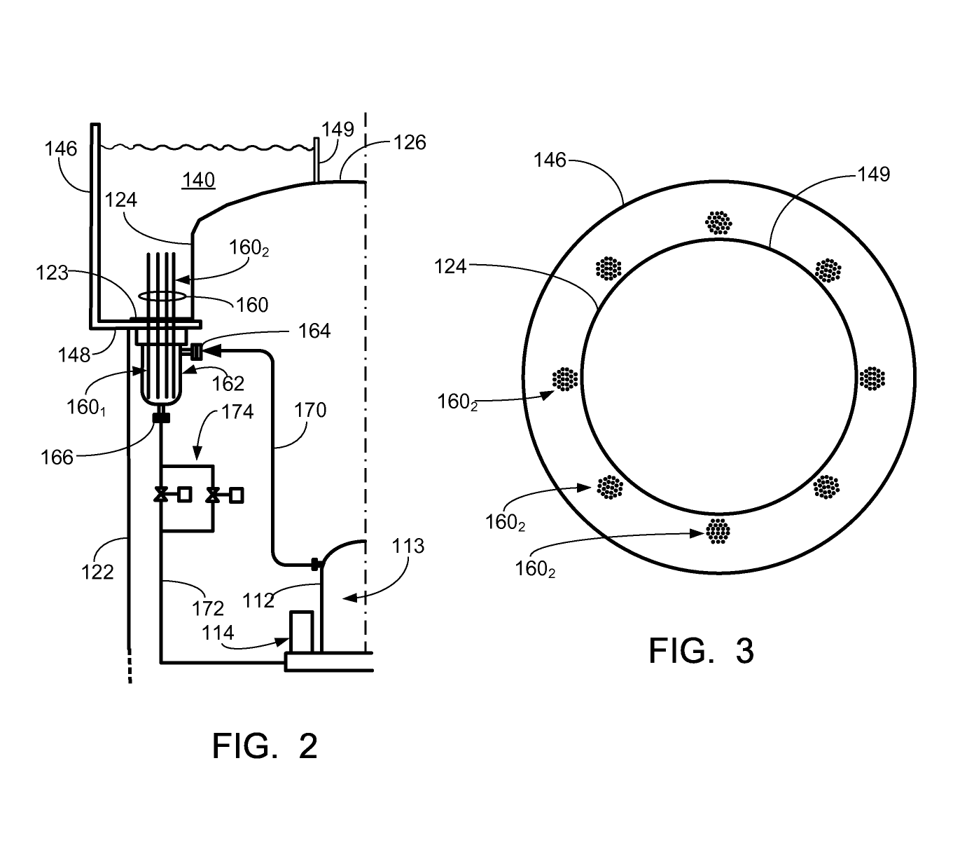

Toward this end, with reference to FIGS. 2 and 3 another embodiment includes a nuclear reactor comprising a pressure vessel 112, of which only an upper portion is visible in the partial view of FIG. 2. The visible portion of the pressure vessel 112 delineates an upper plenum that defines an internal pressurizer 113. Also shown in FIG. 2 is a reactor coolant pump 114 mounted near the top of the pressure vessel proximate to the internal pressurizer 113. Integral PWRs with such an arrangement including an internal pressurizer and a proximate reactor coolant pump are disclosed in further detail in “Pressurized Water Reactor With Upper Vessel Section Providing Both Pressure and Flow Control”, U.S. application Ser. No. 13/109,120 filed May 17, 2011. U.S. application Ser. No. 13/109,120 filed May 17, 2011 is incorporated herein by reference in its entirety. The reactor of FIG. 2 is disposed in a containment structure 122 that is similar to the containment structure 22 of FIG. 1 except that it includes a horizontal annular shelf 123 creating an inner sidewall 124. The containment 122 includes a dome 126 extending to the inner sidewall 124. A secondary containment structure similar to the secondary containment 32 of the embodiment of FIG. 1 may be provided, but is not shown in FIG. 2. An ultimate heat sink (UHS) pool 140 is similar to the UHS pool 40 of FIG. 1, and has an annular sidewall 146 and bottom portion 148. The bottom portion 148 and the annular shelf 123 of the containment structure 122 together define an annular floor of the annular UHS pool 140. The inner boundary of the UHS pool 140 is defined by a second annular sidewall 149 that has no analog in the embodiment of FIG. 1. (Its function is effectively defined by the point where the water level of the UHS pool 40 meets the dome 26).

In the embodiment of FIGS. 2 and 3, eight distinct condensers are defined, only one of which is seen in side sectional view in FIG. 2. While eight condensers are shown, more or less than eight condensers may be utilized. Each condenser includes closed-path heat pipes or closed-path thermosiphons 160 oriented vertically and embedded in the annular shelf 123 of the containment structure 122. The closed-path heat pipes or closed-path thermosiphons 160 include first ends 160₁ protruding downward into the interior volume contained by the containment structure 122, and opposite second ends 160₂ protruding upward outside of the containment 122. The second ends 160₂ are immersed in the UHS pool 140. Additionally, a plenum chamber 162 is disposed inside the containment 122 and surrounds the first ends 160₁. The plenum chamber 162 includes an inlet 164 for admitting steam and an outlet 166 for discharging condensate. The outlet 166 should be at or near the lowest point of the plenum chamber 162 so that the condensate drains into the outlet 166.

The condensers of FIGS. 2 and 3 advantageously can be connected to various ports to provide controlled condenser action. In illustrative FIG. 2, the inlet 164 is connected by piping 170 to the internal pressurizer 113 and the outlet 166 is connected by piping 172 to a pump suction plenum of the reactor coolant pump 114. When a valve assembly 174 is opened this configuration is suitable for remediating a loss of heat sinking accident. The loss of heat sinking causes steam pressure buildup inside the pressure vessel 112, and particularly in the internal pressurizer 113. When the valve assembly 174 is opened this steam flows through piping 170 to the inlet 164 where the closed-path heat pipes or closed-path thermosiphons 160 transfer the heat efficiently into the UHS pool 140. This heat transfer condenses the steam and the condensate drains through outlet 166 and piping 172 to the pump suction plenum of the reactor coolant pump 114. (Another advantage of this configuration is that suction action of the pump 114 can assist in drawing the condensate out of the plenum chamber 162.) It will be appreciated that various piping arrangements can be used; for example, a “T” connection and suitable valves can be added to enable the inlet 164 to be connected to the interior volume of the containment structure 122 for condensing steam released into that volume during a LOCA.

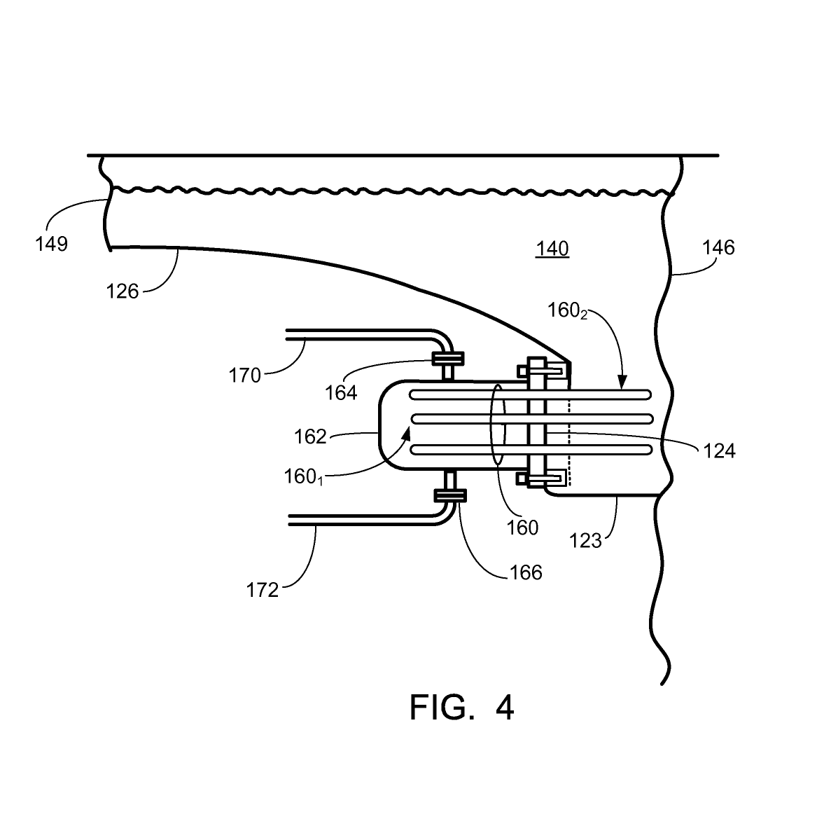

With reference to FIG. 4, an alternative embodiment is shown in which the condenser is mounted on the inner sidewall 124 rather than on the annular shelf 123 of the containment structure 122. In this orientation the closed-path heat pipes 160 are oriented horizontally. Given the strong orientation dependence of thermosiphons and wickless heat pipes, in the embodiment of FIG. 4 the closed-path heat pipes 160 are preferably closed-path heat pipes 160 that include wicks.

The embedding of the heat pipes into a wall or roof of the containment structure can be done in various ways. If the containment is made of steel-reinforced concrete, it may be possible to embed the heat pipes during formation of the concrete. If the containment structure is steel, then one suitable approach is to employ a tubesheet, which can form a portion of the containment wall or roof, and the closed-path heat pipes or closed-path thermosiphons are suitably embedded in the openings of the tubesheet. If the chamber plenum is used to define a controlled volume around the first ends (e.g. plenum chamber 162 surrounding first ends 160₁), then the tubesheet can also define part of the plenum chamber. The working fluid for either thermosiphons or heat pipes is suitably water, although other working fluids or fluid mixtures are also contemplated. In general, the working fluid can be tailored to cover the temperature and pressure range expected to be reached in any credible accident scenario. It is also worth noting that the isolation provided by the closed heat transfer pathways disclosed herein is well-suited to accommodating a hydrogen burn inside containment.

The embodiments of FIGS. 1-4 employ the UHS pool 40, 140 that is in contact with the containment structure 22, 122. In more conventional designs, the UHS pool is spaced apart from the containment structure, and conventionally piping passes through the containment wall or roof to connect the UHS pool with condensers located inside containment. This is readily accommodated in the disclosed approaches by adding a plenum chamber surrounding the second ends protruding away from the containment structure, and flowing the UHS pool water into that plenum.

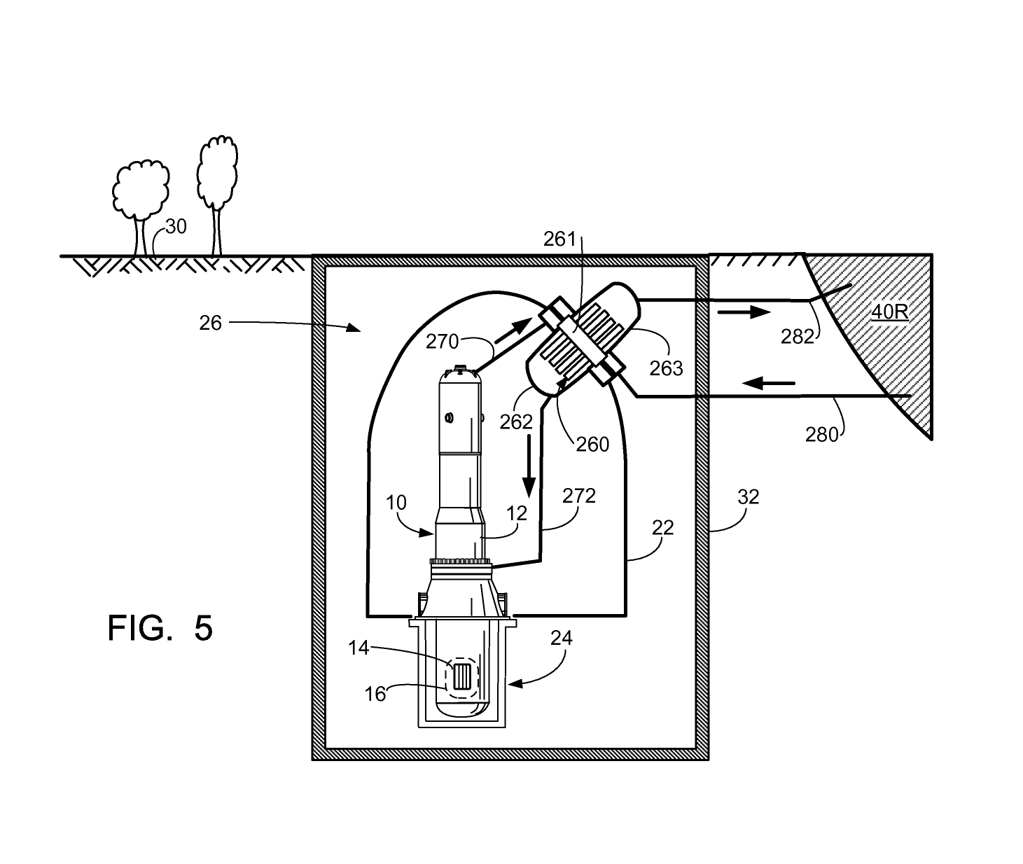

With reference to FIG. 5, such an embodiment is illustrated. The embodiment is substantially similar to the embodiment of FIG. 1, except that the UHS pool 40 of FIG. 1 is replaced by a UHS pool 40R that is spaced apart from the containment structure 22. Closed-path heat pipes or closed-path thermosiphons 260 are embedded in a tubesheet 261 that forms a small portion of the containment dome 26. A first plenum chamber 262 is disposed inside the containment 22 and surrounds the first ends, while a second plenum chamber 263 is disposed outside the containment 22 and surrounds the second ends. Piping 270 conveys steam from the internal pressurizer of the pressure vessel 12 to an inlet of the plenum chamber 262, while piping 272 drains condensate from the plenum chamber 262 back to the pressure vessel 12. These operate similarly to the piping 170, 172 of FIG. 2, except that the piping 272 returns the condensate to around a mid-flange location of the pressure vessel 12.

On the cold side, piping 280 conveys water from the UHS pool 40R into an inlet of the plenum 263 where it receives heat from the second ends of the closed-path heat pipes or closed-path thermosiphons 260. Heated water or steam flows back to the UHS pool 40R via piping 282 to complete the loop.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. An apparatus comprising:
a nuclear reactor including a pressure vessel and a nuclear reactor core contained in the pressure vessel;
a containment structure containing the nuclear reactor;
an ultimate heat sink pool disposed outside of the containment structure; and
a condenser including a plurality of closed-path heat pipes or closed-path thermosiphons having first ends and opposite second ends;
wherein the closed-path heat pipes or thermosiphons are embedded in the containment structure with the first ends contained inside the containment structure and the second ends disposed outside of the containment structure; and
wherein the second ends are in thermal communication with the ultimate heat sink pool.

2. The apparatus of claim 1, wherein the second ends are disposed in the ultimate heat sink pool.

3. The apparatus of claim 2, wherein:
the containment structure is at least partially subterranean and has a heat-sinking top or side that defines a portion of the ultimate heat sink pool, and
the heat pipes are embedded in the heat sinking top or side with the first ends contained inside the containment structure and the second ends disposed in the ultimate heat sink pool.

4. The apparatus of claim 1, wherein the of closed-path heat pipes or closed-path thermosiphons comprise:
vertically oriented closed-path closed-path thermosiphons.

5. The apparatus of claim 1, wherein the closed-path heat pipes or closed-path thermosiphons comprise:
closed-path heat pipes.

6. The apparatus of claim 1, wherein the condenser further comprises:
a plenum chamber contained inside the containment structure and surrounding the first ends, the plenum chamber having an inlet for admitting steam and an outlet for discharging condensate.

7. The apparatus of claim 6, further comprising:
piping providing a fluid connection between a pressurizer of the nuclear reactor and the inlet of the plenum chamber of the condenser, the piping including a valve for opening or closing the fluid connection.

8. The apparatus of claim 7, wherein the nuclear reactor is a pressurized water reactor (PWR) and the pressurizer of the nuclear reactor comprises an internal pressurizer defined by an upper plenum of pressure vessel.

9. The apparatus of claim 6, further comprising:
piping providing a fluid connection between the outlet of the plenum chamber of the condenser and the pressure vessel of the nuclear reactor, the piping including a valve for opening or closing the fluid connection.

10. The apparatus of claim 6, wherein the second ends are disposed in the ultimate heat sink pool.

11. The apparatus of claim 1, wherein the condenser further comprises:
a tubesheet forming a portion of the containment structure wherein the closed-path heat pipes or closed-path thermosiphons are embedded in the openings of the tubesheet with the first ends contained inside the containment structure and the second ends disposed outside of the containment structure.

12. An apparatus comprising:
a condenser including:
a plurality of closed-path heat pipes or closed-path thermosiphons having first ends and opposite second ends, and
a plenum chamber containing the first ends, the plenum chamber having a fluid inlet and a fluid outlet.

13. The apparatus of claim 12, wherein the closed-path heat pipes or closed-path thermosiphons comprise closed-path heat pipes.

14. The apparatus of claim 12, wherein the condenser further comprises:
a tubesheet forming a portion of the plenum chamber wherein the closed-path heat pipes or closed-path thermosiphons are embedded in the openings of the tubesheet with the first ends contained inside the plenum chamber and the second ends extending away from the plenum chamber and away from the tubesheet.

15. The apparatus of claim 14, further comprising:
a containment structure, the condenser being mounted at a wall or roof of the containment structure with the tubesheet forming a portion of said wall or roof.

16. The apparatus of claim 15, further comprising:
a nuclear reactor disposed inside the containment structure.

17. The apparatus of claim 16, wherein a pressurizer of the nuclear reactor is connected with the fluid inlet of the plenum chamber.

18. The apparatus of claim 12, further comprising:
a containment structure containing an interior volume;
wherein the closed-path heat pipes or closed-path thermosiphons are embedded in a wall or roof of the containment structure with the first ends protruding into the interior volume and the second ends protruding away from the containment structure.

19. The apparatus of claim 18, further comprising:
a nuclear reactor disposed in the interior volume and contained by the containment structure.

20. The apparatus of claim 18, further comprising:
a heat sinking pool disposed outside the containment structure, wherein the second ends of the closed-path heat pipes or closed-path thermosiphons extend into the heat sinking pool.

21. An apparatus comprising:
a containment structure containing an interior volume;
a nuclear reactor disposed in the interior volume;
an ultimate heat sink pool disposed outside of the containment structure; and
a condenser including a plurality of closed-path heat pipes or closed-path thermosiphons having first ends and opposite second ends;
wherein the closed-path heat pipes or closed-path thermosiphons are embedded in the containment structure with the first ends protruding into the interior volume and the second ends protruding outside of the containment structure.

22. The apparatus of claim 21, wherein the second ends are immersed in the ultimate heat sink pool disposed outside of the containment structure.

23. The apparatus of claim 21, wherein the ultimate heat sink pool is spaced apart from the containment structure and the condenser further comprises:
a plenum chamber surrounding the second ends of the closed-path heat pipes or closed-path thermosiphons;
wherein piping connects the ultimate heat sink pool and the plenum chamber surrounding the second ends of the closed-path heat pipes or closed-path thermosiphons.

24. The apparatus of claim 23, wherein the condenser further comprises:
a plenum chamber disposed in the interior volume and surrounding the first ends of the closed-path heat pipes or closed-path thermosiphons.

25. The apparatus of claim 21, wherein the condenser further comprises:
a plenum chamber disposed in the interior volume and surrounding the first ends of the closed-path heat pipes or closed-path thermosiphons, the plenum chamber having an inlet for admitting steam and an outlet for discharging condensate.

26. The apparatus of claim 25, wherein the inlet of the plenum chamber surrounding the first ends of the closed-path heat pipes or closed-path thermosiphons is connected with a pressurizer of a nuclear reactor disposed in the interior volume of the containment structure.
